(19) United States
(12) Patent Application Publication
(10) Pub. No.: US 2013/0001099 A1
(43) Pub. Date: Jan. 3, 2013

(54) Method and Apparatus for Cleaning Water Electrochemically

(76) Inventors: Martti Pulliainen, Mikkeli (FI); Mikko Vepsalainen, Helsinki (FI); Niina Vesalainen, Mikkeli (FI); Arash Ghiasvand, Mikkeli (FI); Jouni Rauasmaa, Juva (FI); Isto Virtanen, Mikkeli (FI)

(21) Appl. No.: 13/522,588

(22) PCT Filed: Jan. 13, 2011
(86) PCT No.: PCT/FI2011/050023

§ 371 Date: Sep. 10, 2012

(30) Foreign Application Priority Data
Jan. 19, 2010 (FI) 20105040

(51) Int. Cl. C02F 1/465; C25B 9/16

(52) U.S. Cl. 205/743; 204/228.1

(57) ABSTRACT

The invention relates to a method for cleaning water or an aqueous flow electrochemically by flotating impurities contained in water for collecting the impurities from a surface of the water. The method includes conveying the water flow to be cleaned through at least one particle bed which behaves bipolarically under electric voltage, which bed is formed of an anode and a cathode and metal particles arranged between the anode and the cathode; leading a changing direct current to the particle bed to maintain electrochemical reactions on anodic regions and cathodic regions of the particles; and dissolving metal of the particles electrochemically to water to split water to micro bubbled hydrogen gas H₂ for the flotation and to hydroxide ions OH— for increasing pH of water. The invention relates also to an apparatus for cleaning water or an aqueous flow electrochemically.

### FIELD OF THE INVENTION

The invention relates to a method and an apparatus for cleaning water electrochemically.

### BACKGROUND OF THE INVENTION

Cleaning of water can be divided in mainly two parts: cleaning of raw, i.e., clean water and cleaning of waste water. Generally, cleaning of raw water means producing of drinkable water and quality of water which is released to nature after the cleaning of waste waters shall satisfy permitted limits which are defined in law. Additionally, in future there is demand to increase recycling of process waters wherein cleaning requirement of recycled waters in processes increases.

Loose and larger waste is first filtered from raw water by conveying water through a fine sand filter, for example. Chemical cleaning phases start after the filtering. I.a., phases described in following are present in the chemical cleaning of raw water. Water cleaning chemicals such as iron(II) sulfate, aluminium sulphate or polyaluminium chloride are mixed with raw water to sediment organic material, i.a., phosphates to flakes which are able to settle down and flotate. In sedimentation a precipitate which is treated with a water cleaning chemical is mixed to increase crystal size of the precipitate and to sediment water. After the sedimentation a sediment can be conveyed to treatment of sludge. Sedimented raw water is filtered. Acidity or pH of water can be adjusted suitable with lime water, for instance. Ozone can be used in removing microbes and bacteria etc. contained in raw water what also increases taste and odor of water. Carbon dioxide can yet be added to water a purpose of it being to increase alkalinity of water and so to decrease corrosion caused by water. Water can be conveyed through an activated carbon filter that potential excesses of, for example, humus can be separated. Water can be disinfected with ultraviolet light or by chlorinating after activated carbon filtering, for example.

Patent publication WO 2007/140802 A1 shows an electrolytic process for cleaning waste water. The process comprises at least one upflow electroflocculation cell consisting of a lower electrode which is formed of a porous, non-fluidized bed of loose iron and aluminium granules and an upper electrode which is manufactured of an iron or aluminium mesh. Granules of the bottom electrode are moved by injecting gas pulses. The aluminium and iron ions which are released due to a voltage between the electrodes oxidize and create easy filterable contaminants in a flow of waste water.

Patent publication GB1434594 shows a method and an apparatus for recovering undesired metals in ionic form, i.a., from effluents of industrial processes. Waste water is treated in an abrasive bath formed of metal particles such as iron, aluminium or zinc and sand. A metal particle is more electro-positive than a metal ion to be removed from waste water. The metal recovered from waste water comprises, i.a., copper, cadmium, palladium, lead or tin.

An object of the invention is to reduce use of cleaning chemicals which are mixed with water when water is cleaned.

### SUMMARY

According to a first aspect of the invention there is provided a method for cleaning water or an aqueous flow electrochemically, the method comprising flotating impurities contained in water for collecting the impurities from a surface of the water; conveying the water flow to be cleaned through at least one particle bed which behaves bipolarically under electric voltage, which bed is formed of an anode and a cathode and metal particles arranged between the anode and the cathode; leading a changing direct current to the particle bed to maintain electrochemical reactions on anodic regions and cathodic regions of the particles; and dissolving metal of the particles electrochemically to water to split water to micro bubbled hydrogen gas H₂ for the flotation and to hydroxide ions OH⁻ for increasing pH of water. pH of water may be increased to achieve an optimal precipitation-pH of precipitation processes.

Generally, water is used as a term for aqueous flows to be cleaned in the text describing the invention and its various embodiments in order to simplify the text.

Preferably pH of water to be cleaned is regulated to a desired level before conveying water to the particle bed, preferably to 4.2-4.7, more preferably to 4.5.

Preferably the water flow is conveyed in the particle bed vertically from bottom upwards.

Preferably the impurities in the particle bed are precipitated by means of metal ions dissolved in water.

Preferably cationic precipitation substances are formed with substances which are dissolved from the particle bed to water for neutralizing negatively charged impurities contained in water.

Preferably a surface area ratio of the anode and the cathode is arranged optimal. Preferably the surface area ratio of the anode and the cathode is arranged so that an excessive forming of oxygen on the anode is avoided and for increasing energy efficiency of the water cleaning process. Preferably the surface area ratio of the anode and the cathode is arranged so that an excessive forming of chlorine on the anode is avoided and for increasing energy efficiency of the water cleaning process. The surface area ratio of the anode and the cathode depends on pH of water to be cleaned. With raw water, preferably the surface area ratio of the anode and the cathode is about 3:1.

Preferably potentials of electrodes of the particle bed is measured for controlling desired electrode reactions in the particle bed.

Preferably temperature of water before the particle bed and/or conductivity of water and/or pH of water and/or water with a continuous TOO-measurement (UV-measurement) after the bed is measured for controlling current which is to be connected between primary electrodes of the electrochemical process.

Preferably the reactions of the electrochemical process are regulated with a current to be connected between the electrodes of the particle bed, a rate of the current being altering, preferably by pulsating the current and/or by changing a polarity of the current.

Preferably oxygen O₂ is reduced cathodically to create nitrogen peroxide and to disinfect water.

Preferably chlorine Cl₂ is created anodically to disinfect water.

Preferably aluminium, iron or magnesium or combinations thereof are used as metal particle material in the particle bed.

Preferably a water permeable membrane which isolates different metal particles from each other is arranged between adjacent particle beds which are comprised of different metal particles.

Preferably electricity non-conducting particles are added to the particle bed. A suitable amount of electricity non-conducting particles may be arranged between adjacent particle beds which are comprised of different metal particles. The electricity non-conducting particles which have a suitable size may comprise quartz, plastic etc. granules, for instance.

Preferably the particle bed is moved by means of the water flow for keeping clean and mixing the particle bed.

According to a second aspect of the invention there is provided an apparatus for cleaning raw water electrochemically, the apparatus comprising a flotation part for collecting impurities contained in raw water from a surface of the water. The apparatus comprises at least one particle bed which is through-flowable with water to be cleaned which particle bed behaves bipolarically under electric voltage, which bed is formed of an anode and a cathode and metal particles arranged between the anode and the cathode; and an electricity source for leading a changing direct current to the particle bed between the anode and the cathode to maintain electrochemical reactions on anodic regions and cathodic regions of the particles and for dissolving metal of the particles electrochemically to water to split water to micro bubbled hydrogen gas H₂ for the flotation which is effected in the flotation part and to hydroxide ions OH⁻ for increasing pH of water.

The apparatus may comprise an acidity regulating means before the particle bed in flow direction of water to be cleaned.

The apparatus may comprise a modular cell which is divided in several portions and each portion comprises an individually electrochemically controllable particle bed.

Preferably the particle bed is arranged in a vertical position and the flow is arranged from bottom upwards.

Preferably the particle bed is arranged under the flotation part. A flocculation result increases, that is, the flocs grow better by means of a slow mixing.

Preferably a surface area ratio of the anode and the cathode is arranged to be about 3:1. The surface area ratio of the anode and the cathode depends on the conductivity of water.

Preferably a distance between the anode and the cathode is arranged to 8-12 cm, more preferably about 10 cm. The distance between the anode and the cathode depends on the conductivity of water.

A water permeable membrane which isolates different metal particles from each other may be arranged between different material particle beds for achieving bipolarity. Preferably a suitable amount of electricity non-conducting particles may be added to the particle bed. The electricity non-conducting particles may be arranged between adjacent particle beds which are comprised of different metal particles. The electricity non-conducting particles which have a suitable size may comprise quartz, plastic etc. granules, for instance.

With help of the invention function of a water cleaning cell may be optimized by means of gas bubbles to be created electrochemically on 3D-particles. Costs of water cleaning may be decreased when compared to cleaning with known water cleaning chemicals and environmental friendliness of the cleaning may be increased. Known water cleaning chemicals to be mixed with water are consumed ca. 10 mg/l, whereas according to some embodiments consumption of aluminium, i.a., in electrochemical dissolving may be ca. 5 mg/l.

Different embodiments of the present invention will be illustrated or have been illustrated only in connection with some aspects of the invention. A skilled person appreciates that any embodiment of an aspect of the invention may apply to the same aspect of the invention and other aspects alone or in combination with other embodiments as well.

### BRIEF DESCRIPTION OF THE DRAWINGS

The invention will be described, by way of example, with reference to the accompanying drawings, in which:

FIG. 1 shows schematically electrochemical reactions when aluminium is dissolved in a water cleaning cell;

FIG. 2 shows a water cleaning apparatus; and

FIG. 3 shows an embodiment of the water cleaning apparatus of FIG. 2.

### DETAILED DESCRIPTION

In the following description, like numbers denote like elements. It should be appreciated that the illustrated drawings are not entirely in scale, and that the drawings mainly serve the purpose of illustrating embodiments of the invention.

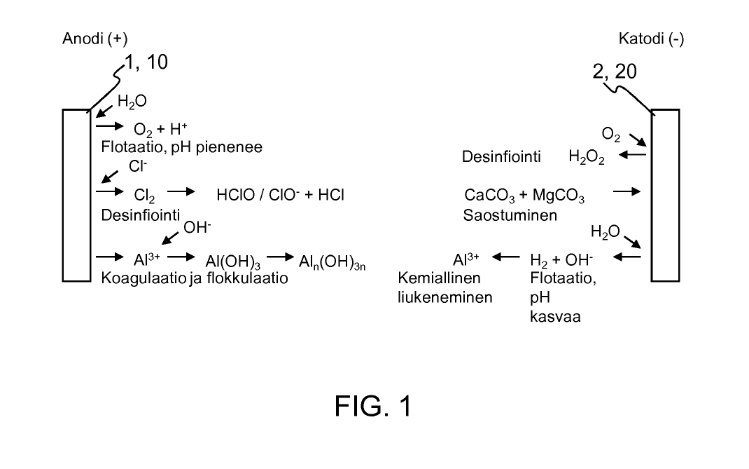

FIG. 1 shows schematically electrochemical reactions which take place on an anode 1 (anodic regions of particles) and a cathode 2 (cathodic regions of particles) of an electrochemical particle bed of a water cleaning apparatus. As particles in the bed have been described Al in the example of FIG. 1 but also other metals may be used in a way described later. Raw water, for instance, is conveyed through electricity conducting particles forming the particle bed for cleaning raw water. Electrochemical reactions are created between the anodes 1 and the cathodes 2 by means of electric current for cleaning water or an aqueous flow. Material transfer reactions are effected on surface of the particles in the water cleaning apparatus. There is an attempt to maximize these reactions by arranging material, which is split in small pieces, to the bed in a cell structure in the water cleaning apparatus wherein a reaction area of the material is largest. The metal particles forming the bed may be, for example, in form of granules, small pieces, or groats for enlarging the reaction area. The material particles may be aluminium or, according to some embodiments, iron metal or magnesium or a mixture of at least two of these or of all these metals. In order to attain bipolarity a water permeable membrane which isolates different metal particles from each other may be arranged between adjacent metal particle beds or a suitable amount of electricity non-conducting quartz, plastic etc. granule with suitable size may be added to the bed (not shown in the figures).

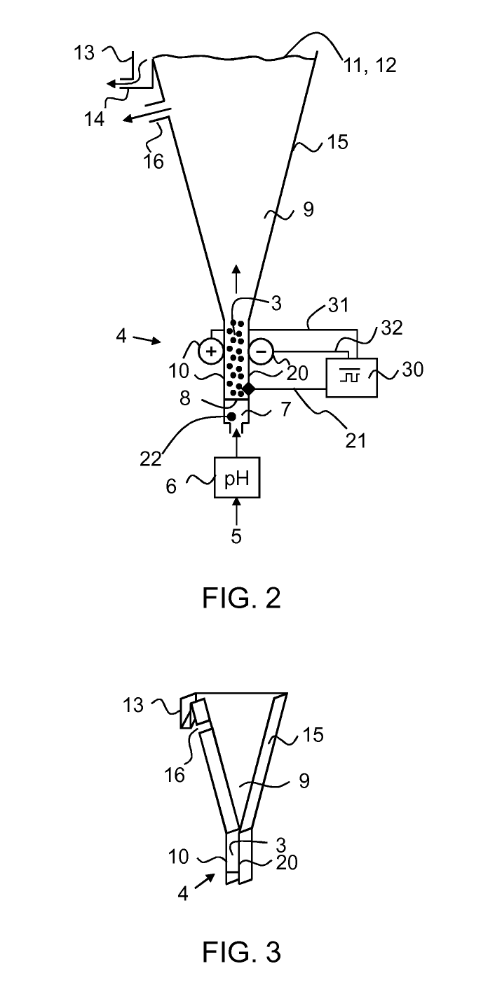

The metal particles dissolve in the water (e.g., raw water) or another aqueous flow to be treated which is fed through the particle bed 3 when voltage is coupled between the anode 10 and the cathode 20 in a cell 4 (FIG. 2). By leading the voltage to the bed 3 it is attempted to change the bed bipolar where each particle may have both anodic regions 1 and cathodic regions 2. Cationic precipitation substances are formed with substances which are dissolved from the metal particle bed 3 to water, which cationic precipitation substances are used for neutralizing negatively charged substances contained in water which are classified as impurities. Chlorine which is released in a controlled minor way from the anode 1 is suitable for disinfecting water, as well as nitrogen peroxide which is released in a controlled minor way from the cathode. Additionally, sediment is formed by means of precipitation substances. Hydrogen micro bubbles created in a controlled way in the electrochemical reaction of the cell, when metal ions dissolve in water, bear the sediment in an upwards flow of the cell. The sediment is transferred with the bubbles in direction of the water flow preferably above the bed. According to some embodiments drinkable water may be gotten from the water cleaning apparatus, in some cases after a necessary additional filtering.

A water cleaning apparatus is shown from aside in FIG. 2, comprising preferably a cell 4 equipped with a bed 3 formed of aluminium granules for treating water to be cleaned. Water flows through the cell 4 from bottom upwards in FIG. 2. When flowing upwards no pockets can be formed where to gas could gather or where flowing is poor. Flow directions of water are depicted with arrows. Water to be cleaned enters the water cleaning apparatus in place 5 to an acidity regulating means 6. After regulating a pH which is suitable for a starting situation of electrochemical reactions of the water cleaning process water is conveyed to a distribution space 7 of the cell 4, where from the flow is distributed to the bed 3 from bottom upwards. Preferably, pH is regulated to be about 4.2 to 4.5 before the cell 4 and pH decreases in the cell. A minimum solubility point of aluminium to water is in a pH of about 6. Thus, pH has to increase in the cell 4 up to that value or more that aluminium precipitates effectively impurities and that a residual amount of aluminium in water stays sufficient small.

Particles are located between primary electrodes 10, 20 (supply electrodes of electric current) at sides of the cell 4 to the bed 3 which behaves bipolarically in electric current. The particles rest on a water flow permeable wall 8 which is arranged between outer walls of the cell. Aluminium is dissolved electrochemically to a water treatment chemical in the cell 4. It is possible to get aluminium react simultaneously both in anodic and cathodic direction. A polarization is then about one volt. Both anodic dissolving of aluminium and creation of hydrogen is achievable with such a voltage difference. Aluminium can be dissolved cathodic by means of pH. An increase of pH on the cathode intensifies the electrochemical reactions effected on the cathode. pH of water has increased after the cell 4 and according to some embodiments pH values 5.95 to 6.2 have been measured of water after the cell, when the value before the cell was 4.2 to 4.5.

Function of the water cleaning apparatus shown in FIG. 2 can be improved compared to known solutions by creating electrochemically gas bubbles on surfaces of the aluminium particles of the three dimensional cell 4.

There has been strong prejudice in the past towards such processes where hydrogen gas is treated because hydrogen forms an easy exploding gas mixture together with oxygen contained in air.

In the method according to the invention and in the cell 4 of the water cleaning apparatus, however, it is desired to create micro bubbled hydrogen gas H₂ on the cathodic regions 2 of the particles when aluminium of the particle dissolves cathodic to water to aluminium ions Al³⁺ and water splits to hydrogen gas H₂ and hydroxide ions OH⁻. When a portion of the hydroxide ions increases, pH rises high and enhances the dissolving of aluminium from cathode surfaces to water.

A flotation can substantially be enhanced by means of hydrogen gas H₂ formed as micro bubbles. In the anode reactions taking place on anodic regions 1 of the particles the hydroxide ions OH⁻ in water react with aluminium Al³⁺ which is dissolved in water. Then, aluminium acts in water as a coagulant forming precipitated impurity flakes. Hydrogen bubbles created in the cathode reactions lift the created floc to the surface. Substance parts of the impurities stick in the micro bubbles which travel in upwards flow of the cell 4, preferably above the cell 4. It is recommendable to arrange the flow direction of water whole time upwards up to a flotation part 9 which follows the cell 4. A flocculate 12 which is rising to a surface of water in the flotation part 9 of the water cleaning apparatus can be skimmed away from the surface. The flocculate 12 can be skimmed, for example, via an overflow which is formed by a trough 13 to a waste water treating system 14. Water cleaned in the water cleaning apparatus is conveyed via an outlet channel 16 which is formed in a wall 15 of the flotation part 9 out of the water cleaning apparatus.

The cell 4 is preferably a kind of combination of a packed bed and a fluidized bed where the particles forming the bed 3 can slightly move due to the flow of water to be cleaned and/or the particles can be moved.

A flow speed in the cell 4 is attained to adapt such that reaction products such as hydrogen gas bubbles H₂ and aluminium hydroxide Alₙ(OH)₃ₙ come out from the cell evenly. Gas yield, production of desired gases, size of the gas bubbles can be controlled in a desired way in the cell by means of suitable value of direct current, form of the direct current, pulsating of the direct current and surface area ratios of the electrodes 10, 20. With raw water the anode 10/cathode 20 surface area ratio is preferably ca. 3:1. A distance between the anode 10 and the cathode 20 is preferably ca. 10 cm.

When the surface area of the anode is selected to be larger than of the cathode, preferably with the anode 10/cathode 20 surface area ratio ca. 3:1, development of hydrogen can effectively be optimized on cathode regions 2 of the particles and a creation of side reactions which is typical for this process can be reduced, for example, development of oxygen on anode regions 1. Large bubbles of oxygen disturb a coagulation. A particular benefit from the selection of the surface area ratio in this way brings also the amount of energy which is saved. Also a creation of chlorine on the anode regions 1 which is larger than desired can be restricted when the surface area ratio of the anode is selected larger than that of the cathode.

Patent publication F1991116 shows a corrosion prevention method in which electrochemical properties of an electrolyte in changing conditions are measured by a detector and an optimum potential is determined on the basis of the measurement results, and the current supplied by a current source is changed such that the optimum potential is achieved.

The way of measuring and controlling, and pulsating and design of direct current described in publication F1991116 can be implemented in the present water cleaning method and apparatus for controlling the electrochemical reactions of the cell 4. Changing polarity is also a possible controlling way of an electricity source. It is recommendable to pulsate the amount of current and so to change current levels of the direct current. Voltage of the electricity source 30 can with raw water be preferably 40 to 120 V. The current in the cell 4 was 2.8 A in a test environment. A cathodic potential was in average −10.67 V and an anodic potential in average 1.79 V.

The water cleaning apparatus comprises an electricity source 30, a plus pole of which is coupled to the primary anode 10 of the cell 4 with a first current conductor 31. A minus pole of the electricity source 30 is coupled to the primary cathode 20 of the cell with a second current conductor 32. A potential measurement 21 of the primary cathode 20 can be used as a feedback coupled measurement data in controlling the voltage of the electricity source 30. The measurement can be made on-line. At least one sensor (not shown) can be located in the cell 4 of the water cleaning apparatus or after the cell 4 to measure electricity conductivity of water for determination of an optimum potential of the electricity source 30. At least one water temperature measuring sensor 22 can be located at a flow path of water for changing the optimum potential of the electricity source 30, preferably in a location before the particle bed 3. At least one water acidity pH measuring sensor can be located in the flow of water for changing the optimum potential of the electricity source 30, preferably in a location before the particle bed 3. The current of the electricity source is increased or decreased or the pulsating of the current is controlled on the basis of the measurement data. pH of water is regulated by the acidity regulating means 6 preferably before the cell 4. A series of electrodes are arranged preferably in the cell 4 wherein the polarity of the primary electrodes 10, 20 can be circulated. The series of electrodes can be implemented by a cell 4 which is divided in parts wherein there are primary electrodes per part in each part of the cell. Such a modular cell 4 in which a certain part of the electrodes is at a time cathodes and anodes and the polarity of these cathodes and anodes is changed are advantageous amongst other things because of the staying clean of the cell 4.

Preferably the measurement of electricity conductivity of electrolyte or water before the cell 4, in the cell and/or after the cell is used as one controlling factor of the water cleaning process.

In a process according to an embodiment the conductivity of the inflowing water was 49 to 53 μS/cm and the conductivity of the outflowing water was 37 to 39 μS/cm. The temperature of the inflowing water was 12 to 39° C.

Size of the particles can be used as a controlling factor of the water cleaning process of the cell 4. There is a risk of blockage of the cell with a too small particle or granule size, and when the particle size increases too much a performance of the cell decreases. Pure aluminium can be used as particles, 99.9% Al, for instance, which shall not contain heavy metals to ensure drinkability of water. A finest part of the particles moves to a sludge when the particles get worn out and the amount which is worn out is replaced according to the consumption.

The temperature of water to be cleaned is recommended to be more than 10° C., more preferably more than 12° C., for controlling the function of the cell 4.

The cell 4 is preferably hold clean and active by moving the particles of the cell. The particles such as Al granules forming the bed 3 can be moved mechanically. The bed can be “liquefied” and fluidized. The granules can be circulated or moved by compressed air or inert gas such as nitrogen or carbon dioxide. According to a very advantageous embodiment the particles can be moved by means of the flow of water, for instance, by spraying pressurized water to the bed and/or in the bed. Using water instead of gas helps to keep developed flocs and developing flocs better together. The particles can be affected with pressurized water and/or pressurized gas from under the bed and/or from inside the bed. The particles can be released from another and packed again against another with pressurized water and/or pressurized gas to clean the surface of the particles and to mix or organize them again. Passivation and channelling of the bed can so be prevented and distribution of the liquid flow evenly in the bed can be advanced when the cell is used. Activating the bed by moving the particles can be controlled by using quantities to be measured, if desired, from the process as a control data, the quantities being such as potential difference of the cell, turbidity of water which has passed the cell, pressure drop over the cell, TOC-value of water which has passed the cell (total organic carbon, total amount of organic carbon), COD-value of water which has passed the cell (chemical oxygen demand, amount of materials which consume oxygen). When one or some of these quantities exceeds a set value, pressurized water and/or pressurized gas can be directed to the bed. Preferably a particle moving effect can be directed to the bed, for example, after a certain time, for example, in certain time intervals. The particles of the bed can be moved, for example, every 5, 10, 15 or 20 minutes. The moving effect such as a pressurized water spray can be directed to the particles of the bed, for example, a time of 15 seconds.

In an advantageous embodiment the thickness of the Al bed 3 is 0.5 to 0.7 m and the amount 5-6 m³/100 l/s water supply. The A- particle bed can be divided in 1 to 5 separate cell parts. The distribution advances, i.a., a suitable guidance of the water flow. Each part can be controlled more individually than a large cell when the cell is divided in parts. The total area of the bed is ca. 10 m² (horizontal section). The flow direction of water in the cell is arranged from bottom upwards wherein the buoyancy of hydrogen in the flocculation can be exploited. A porosity of the bed is ca. 50%. In this example the consumption of Al granules is 45 to 70 kg/d or 1% of the volume of Al granules of the bed has to be replaced during one day.

It is recommendable to take into consideration the side flows in the cell 4 and in the vicinity of the cell, for instance, so that metallic construction and support materials of the cell (not shown in the figures) are isolated or that they are formed of electricity non-conducting materials.

FIG. 3 shows a perspective view of an embodiment of the water cleaning apparatus of FIG. 2. The vertical cross section shown in FIG. 2 is in a manner stretched in longitudal direction. The cell 4 of the apparatus has a form of a rectangular prism, and the flotation part 9 above the cell has a form of a longitudal funnel which expands from bottom upwards.

According to some embodiments the water cleaning apparatus comprises a circular shaped horizontal cross section. According to some embodiments the vertical cross section of FIG. 2 has been rotated about its center axis wherein a form of the water cleaning apparatus is created somewhat rotational symmetric and funnel-like. The horizontal cross section of the cell 4 may then be circular. Preferably the cell is then hollow in the centre wherein the electrodes (and/or the outer walls of the cell) may be formed of an inner tube and an outer tube which surrounds the inner tube, the flow of water to be cleaned is conveyed through the bed 3 between the inner tube and the outer tube.

The foregoing description provides non-limiting examples of some embodiments of the invention. It is clear to a person skilled in the art that the invention is not restricted to details presented, but that the invention can be implemented in other equivalent means. Some of the features of the above-disclosed embodiments may be used to advantage without the use of other features.

As such, the foregoing description shall be considered as merely illustrative of the principles of the invention, and not in limitation thereof. Hence, the scope of the invention is only restricted by the appended patent claims.

1-22. (canceled)

23. A method for cleaning water or an aqueous flow electrochemically, the method comprising flotating impurities contained in water for collecting the impurities from a surface of the water, conveying the water flow to be cleaned through at least one particle bed which behaves bipolarically under electric voltage, which bed is formed of an anode and a cathode and metal particles arranged between the anode and the cathode, leading a direct current to the particle bed to maintain electrochemical reactions on anodic regions and cathodic regions of the particles, and dissolving metal of the particles electrochemically to water to split water to micro bubbled hydrogen gas H₂ for the flotation and to hydroxide ions OH— for increasing pH of water, wherein the method comprises
leading a changing direct current to the particle bed;
measuring electrode potentials of the electrodes of the particle bed for controlling electrode reactions in the particle bed; and
controlling electrode reactions on the anode and the cathode of the particle bed based on the potential measurement so that excessive development of oxygen on the anode is avoided.

24. The method of claim 23, comprising regulating pH of water to be cleaned to a desired level before conveying water to the particle bed, preferably regulating pH to 4.2-4.7, more preferably to 4.5.

25. The method of claim 23, comprising conveying the water flow in the particle bed vertically from bottom upwards.

26. The method of claim 23, comprising precipitating the impurities in the particle bed by means of metal ions dissolved in water.

27. The method of claim 23, comprising forming cationic precipitation substances with substances which are dissolved from the particle bed to water for neutralizing negatively charged impurities contained in water.

28. The method of claim 23, comprising arranging a surface area ratio of the anode and the cathode so that an excessive forming of oxygen and/or chlorine on the anode is avoided and for increasing energy efficiency of the water cleaning process, preferably arranging the surface area ratio of the anode and the cathode to be about 3:1.

29. The method of claim 23, comprising measuring: temperature of water before the particle bed; and/or conductivity of water after the bed; and/or pH of water after the bed; and/or water with a continuous TOC-measurement after the bed; for controlling current which is to be connected between primary electrodes of the electrochemical process.

30. The method of claim 23, comprising regulating the reactions of the electrochemical process with a current to be connected between the electrodes of the particle bed, a rate of the current being altering, preferably by pulsating the current and/or by changing a polarity of the current.

31. The method of claim 23, comprising reducing cathodically oxygen O₂ to create nitrogen peroxide and to disinfect water.

32. The method of claim 23, comprising creating anodically chlorine Cl₂ to disinfect water.

33. The method of claim 23, comprising using aluminium, iron or magnesium or combinations thereof as metal particle material in the particle bed.

34. The method of claim 23, comprising arranging a water permeable membrane which isolates different metal particles from each other between adjacent particle beds which are comprised of different metal particles.

35. The method of claim 23, comprising adding electricity non-conducting particles to the particle bed, preferably arranging the electricity non-conducting particles between adjacent particle beds which are comprised of different metal particles.

36. The method of claim 23, comprising moving the particle bed by means of the water flow for keeping clean and mixing the particle bed.

37. An apparatus for cleaning water or an aqueous flow electrochemically, the apparatus comprising a flotation part for collecting impurities contained in water from a surface of the water, at least one particle bed which is through-flowable with water to be cleaned which particle bed behaves bipolarically under electric voltage, which bed is formed of an anode and a cathode and metal particles arranged between the anode and the cathode, an electricity source for leading a direct current to the particle bed between the anode and the cathode to maintain electrochemical reactions on anodic regions and cathodic regions of the particles and for dissolving metal of the particles electrochemically to water to split water to micro bubbled hydrogen gas H₂ for the flotation which is effected in the flotation part and to hydroxide ions OH⁻ for increasing pH of water, wherein the apparatus comprises
an electricity source for leading a changing direct current to the particle bed;
measuring means which are adapted to measure electrode potentials of the electrodes of the particle bed for controlling electrode reactions in the particle bed; and
control means which are adapted to control electrode reactions on the anode and the cathode of the particle bed based on the potential measurement so that excessive development of oxygen on the anode is avoided.

38. The apparatus of claim 37, wherein the apparatus comprises an acidity regulating means before the particle bed in flow direction of water to be cleaned.

39. The apparatus of claim 37, wherein the apparatus comprises a modular cell which is divided in several portions and each portion comprises an individually electrochemically controllable particle bed.

40. The apparatus of claim 37, wherein the particle bed is arranged in a vertical position and the flow is arranged from bottom upwards.

41. The apparatus of claim 37, wherein the particle bed is arranged under the flotation part.

42. The apparatus of claim 37, wherein a surface area ratio of the anode and the cathode is arranged to be about 3:1.

43. The apparatus of claim 37, wherein a distance between the anode and the cathode is arranged to 8-12 cm, preferably about 10 cm.
